(19) United States
(12) Patent Application Publication
(10) Pub. No.: US 2019/0195680 A1
(43) Pub. Date: Jun. 27, 2019

(54) ABNORMALITY DETECTION DEVICE, DIFFERENCE VECTOR DISPLAY DEVICE, ROTARY MACHINE SYSTEM, ABNORMALITY DETECTION METHOD, AND PROGRAM

(71) Applicant: MITSUBISHI HEAVY INDUSTRIES COMPRESSOR CORPORATION, Tokyo (JP)

(72) Inventors: Satoshi Saburi, Tokyo (JP); Kyoichi Ikeno, Hiroshima-shi (JP)

(73) Assignee: MITSUBISHI HEAVY INDUSTRIES COMPRESSOR CORPORATION, Tokyo (JP)

(21) Appl. No.: 16/226,043

(22) Filed: Dec. 19, 2018

(30) Foreign Application Priority Data
Dec. 21, 2017 (JP) 2017-245561

(51) Int. Cl. G01H 1/00; G01H 1/10; G01M 13/045

(52) U.S. Cl. CPC G01H 1/006; G01M 13/045; G01H 1/10

(57) ABSTRACT

An abnormality detection device includes a vibration measurement value acquisition unit configured to acquire a measurement value of vibration of a rotation shaft, which is measured by each of shaft vibration sensors provided to be spaced apart in a diameter direction of the rotation shaft with respect to an outer circumferential surface of the rotation shaft at positions spaced apart in a shaft direction of the rotation shaft, for each rotation angle of the rotation shaft, a vibration vector calculation unit configured to calculate a vibration vector indicating a rotation angle at which a vibration of the rotation shaft is a maximum and a magnitude of the vibration on the basis of the measurement value of the vibration, and an estimation unit configured to estimate an abnormality occurrence position in the shaft direction of the rotation shaft on the basis of a time change in the vibration vector.

### BACKGROUND OF THE INVENTION

### Field of the Invention

The present invention relates to an abnormality detection device, a difference vector display device, a rotary machine system, an abnormality detection method, and a program.

Priority is claimed on Japanese Patent Application No. 2017-245561, filed Dec. 21, 2017, the content of which is incorporated herein by reference.

### Description of Related Art

Several technologies have been proposed in relation to monitoring of shaft vibration of a rotary machine such as a turbine.

For example, an unstable vibration monitoring device according to Japanese Unexamined Patent Application, First Publication No. 2001-142529 (hereinafter, referred to as Patent Literature 1) performs filtering for extracting only a signal of a target frequency domain from a vibration signal, and samples a filtered vibration signal. This unstable vibration monitoring device plots coordinate values by combining two consecutive sampling values such that an Nth sampling value is taken on a horizontal axis and an N+1th sampling value is taken on a vertical axis, thereby creating a pattern referred to as a phase spatial trajectory. Furthermore, this unstable vibration monitoring device rotates such that a long axis of the phase spatial trajectory is parallel to an X axis, and performs circular transformation that extends in the vertical direction. Then, this unstable vibration monitoring device determines whether there is an unstable vibration on the basis of a distance from an origin of a plot point.

### SUMMARY OF THE INVENTION

It is preferable not only to detect the presence or absence of an abnormality but also to obtain information for maintenance work of a rotary machine in the monitoring of shaft vibration of the rotary machine.

The present invention provides an abnormality detection device, a difference vector display device, a rotary machine system, an abnormality detection method, and a program which can obtain information for maintenance work of a rotary machine.

According to a first aspect of the present invention, an abnormality detection device includes a vibration measurement value acquisition unit configured to acquire a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft, a vibration vector calculation unit configured to calculate a vibration vector, the vibration vector indicating a rotation angle at which vibration of the rotation shaft is a maximum and a magnitude of the vibration on the basis of the measurement value of the vibration, and an estimation unit configured to estimate an abnormality occurrence position in the shaft direction of the rotation shaft on the basis of a time change in the vibration vector.

The shaft vibration sensors may also be provided in respective diameter directions of the rotation shaft orthogonal to each other.

The estimation unit may estimate an abnormality occurrence position in the shaft direction of the rotation shaft on the basis of a rotation speed of the rotation shaft in addition to a time change in the vibration vector.

According to a second aspect of the present invention, a difference vector display device includes a vibration measurement value acquisition unit configured to acquire a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft, a vibration vector calculation unit configured to calculate a vibration vector, the vibration vector indicating a rotation angle at which vibration of the rotation shaft is a maximum and a magnitude of the vibration on the basis of the measurement value of the vibration, a difference vector calculation unit configured to calculate a difference vector indicating a time change in the vibration vector, and a display unit configured to display the difference vector.

According to a third aspect of the present invention, a rotary machine system includes a rotary machine, and an abnormality detection device, in which the rotary machine includes a rotation shaft, and a plurality of shaft vibration sensors provided to be spaced apart in a diameter direction of the rotation shaft with respect to an outer circumferential surface of the rotation shaft and provided to be spaced apart in a shaft direction of the rotation shaft, and the abnormality detection device includes a vibration measurement value acquisition unit configured to acquire a measurement value of vibration of the rotation shaft measured by the shaft vibration sensor for each rotation angle of the rotation shaft, a vibration vector calculation unit configured to calculate a vibration vector, the vibration vector indicating a rotation angle at which the vibration of the rotation shaft is a maximum and a magnitude of the vibration on the basis of the measurement value of the vibration, and an estimation unit configured to estimate an abnormality occurrence position in the shaft direction of the rotation shaft on the basis of a time change in the vibration vector.

According to a fourth aspect of the present invention, an abnormality detection method includes acquiring a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft, calculating a vibration vector, the vibration vector indicating a rotation angle at which vibration of the rotation shaft is a maximum and a magnitude of the vibration on the basis of the measurement value of the vibration, and estimating an abnormality occurrence position in the shaft direction of the rotation shaft on the basis of a time change in the vibration vector.

According to a fifth aspect of the present invention, a non-transitory computer-readable recording medium storing a program causes a computer to execute acquiring a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft, for each rotation angle of the rotation shaft, calculating a vibration vector, the vibration vector indicating a rotation angle at which vibration of the rotation shaft is a maximum and a magnitude of the vibration on the basis of the measurement value of the vibration, and estimating an abnormality occurrence position in the shaft direction of the rotation shaft on the basis of a time change in the vibration vector.

According to the abnormality detection device, the difference vector display device, the rotary machine system, the abnormality detection method, and the program, it is possible to obtain information for maintenance work of a rotary machine.

### BRIEF DESCRIPTION OF THE DRAWINGS

FIG. 1 is a schematic block diagram which shows a functional configuration of a rotary machine system according to a first embodiment of the present invention.

FIG. 2 is a diagram which shows an example of installation positions of a shaft vibration sensor and a rotation pulse sensor in a shaft direction (a longitudinal direction) of a rotation shaft according to the first embodiment.

FIG. 3 is a diagram which shows an example of an installation position of a front-side shaft vibration sensor in a circumferential direction of the rotation shaft according to the first embodiment.

FIG. 4 is a diagram which shows an example of an installation position of a rear-side shaft vibration sensor in the circumferential direction of the rotation shaft according to the first embodiment.

FIG. 5 is a diagram which shows an example of an initial value of a vibration vector calculated by a vibration vector calculation unit according to the first embodiment.

FIG. 6 is a diagram which shows an example of a data structure of vibration vector initial value data stored in a storage unit according to the first embodiment.

FIG. 7 is a diagram which shows an example of a vibration vector after vibration of the rotation shaft according to the first embodiment has changed.

FIG. 8 is a diagram which shows a calculation example of a difference vector according to the first embodiment.

FIG. 9 is a diagram which shows a display example of the difference vector according to the first embodiment.

FIG. 10 is a diagram which shows examples of difference graphs calculated by a difference vector calculation unit according to the first embodiment for each shaft vibration sensor.

FIG. 11 is a diagram which shows an example of a data structure of abnormality occurrence position data stored in the storage unit according to the first embodiment.

FIG. 12 is a diagram which shows a display example of an abnormality occurrence position in the rotation shaft according to the first embodiment.

FIG. 13 is a flowchart which shows an example of a processing procedure in which an abnormality detection device according to the first embodiment generates and stores a vibration vector initial value.

FIG. 14 is a flowchart which shows an example of a processing procedure in which the abnormality detection device according to the first embodiment estimates an abnormality occurrence position in the rotation shaft.

FIG. 15 is a schematic block diagram which shows a functional configuration of a rotary machine system according to a second embodiment of the present invention.

FIG. 16 is a flowchart which shows an example of a processing procedure in which a difference vector display device according to the second embodiment calculates and displays a difference vector.

### DETAILED DESCRIPTION OF THE INVENTION

Hereinafter, embodiments of the present invention will be described, but the following embodiments do not limit the invention according to the claims. In addition, not all combinations of features described in the embodiments are necessarily essential to the solutions of the invention.

### First Embodiment

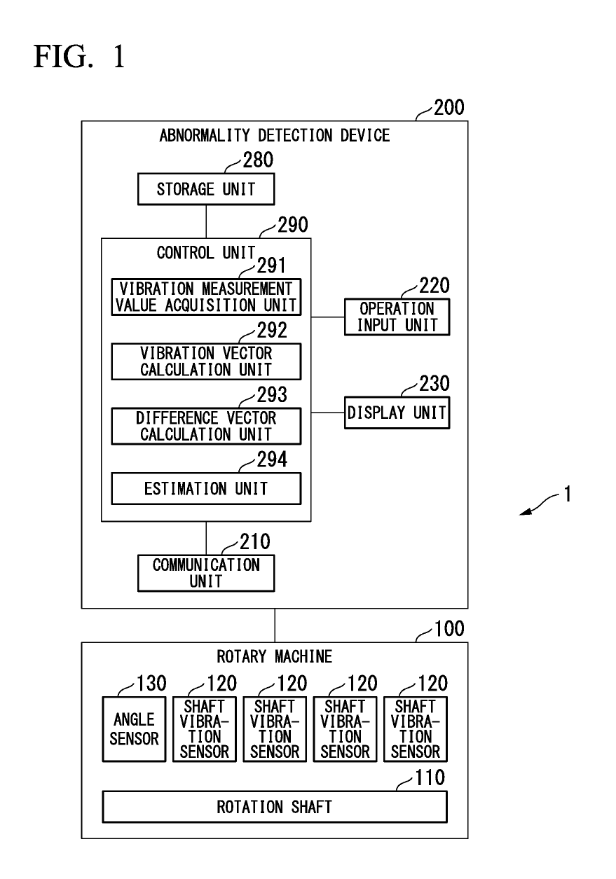

FIG. 1 is a schematic block diagram which shows a functional configuration of a rotary machine system according to a first embodiment of the present invention. As shown in FIG. 1, a rotary machine system 1 includes a rotary machine 100 and an abnormality detection device 200. The rotary machine 100 includes a rotation shaft 110, shaft vibration sensors 120, and an angle sensor 130. The abnormality detection device 200 includes a communication unit 210, an operation input unit 220, a display unit 230, a storage unit 280, and a control unit 290. The control unit 290 includes a vibration measurement value acquisition unit 291, a vibration vector calculation unit 292, a difference vector calculation unit 293, and an estimation unit 294.

The rotary machine 100 is a machine including a rotation shaft. In the following description, a case in which the rotary machine 100 is a steam turbine will be described as an example, but the present invention is not limited thereto. For example, the rotary machine 100 may also be a compressor or a gas turbine.

The rotation shaft 110 rotates in accordance with an operation of the rotary machine 100. In the following description, a case in which the rotation shaft 110 is a rotor of a steam turbine will be described as an example.

The shaft vibration sensors 120 measure vibration of the rotation shaft 110. When the rotation shaft 110 rotates, the shaft vibration sensors 120 measure the vibration of the rotation shaft 110 over the entire circumference of the rotation shaft 110. For example, the shaft vibration sensors 120 may be configured using distance sensors, and may measure distances from the shaft vibration sensors 120 themselves to the rotation shaft 110.

The angle sensor 130 measures a rotation angle (a phase) of the rotation shaft 110.

Here, it is possible to configure the angle sensor 130 using a rotation pulse sensor. The rotation pulse sensor outputs a pulse waveform whenever it passes through a point fixed to a rotor (the rotation shaft 110) (generally indicated by a reflective tape or slit). If the rotor rotates one rotation after a certain pulse is output, another pulse is output. Since the rotation shaft 110 rotates 360 degrees at intervals between adjacent pulses, it is possible to ascertain a rotor angle at which shaft vibration is increased with the point fixed to the rotor set as a reference by observing a pulse waveform at a time at which the shaft vibration is increased.

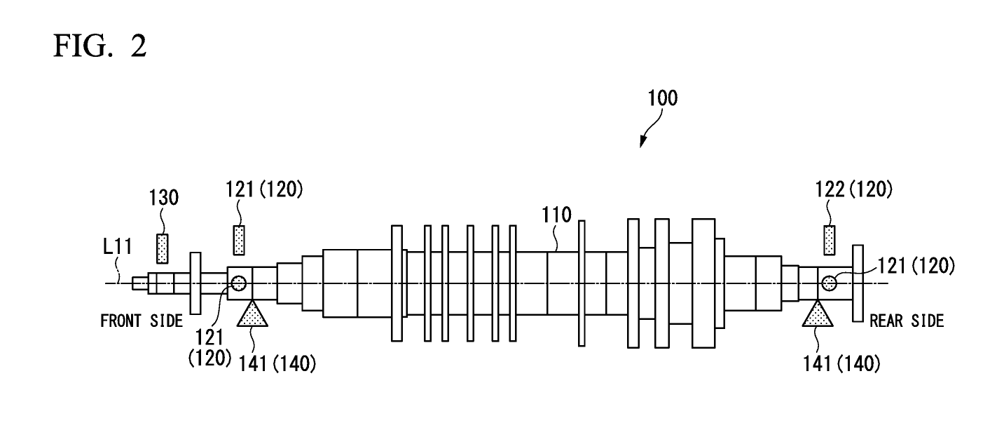

FIG. 2 is a diagram which shows an example of installation positions of the shaft vibration sensors 120 and the rotation pulse sensor (the angle sensor 130) in a shaft direction (a longitudinal direction) of the rotation shaft 110. A left side of the rotation shaft 110 shown in FIG. 2 is a front side, and a right side thereof is a rear side. A line L11 indicates a rotation center of the rotation shaft 110.

In addition, bearings 140 which support the rotation shaft 110 are shown in FIG. 2. Of the bearings 140, the bearing 140 on the front side of the rotation shaft 110 is referred to as a front-side bearing 141, and the bearing 140 on the rear side of the rotation shaft 110 is referred to as a rear-side bearing 142.

In addition, the shaft vibration sensors 120 and the angle sensor 130 are provided to be spaced apart in a diameter direction of the rotation shaft 110 with respect to an outer circumferential surface of the rotation shaft 110.

Two of the shaft vibration sensors 120 are provided near the front-side bearing 141 or further forward on the rotation shaft 110 than the front-side bearing 141, and two are provided near the rear-side bearing 142 or further rearward on the rotation shaft 110 than the rear-side bearing 142. In the arrangement shown in FIG. 2, the shaft vibration sensors 120 positioned on the front side of the rotation shaft 110 are referred to as front-side shaft vibration sensors 121. The shaft vibration sensors 120 positioned on the rear side of the rotation shaft 110 are referred to as rear-side shaft vibration sensors 122.

In this manner, the plurality of shaft vibration sensors 120 are provided to be spaced apart in the diameter direction of the rotation shaft 110 with respect to the outer circumferential surface of the rotation shaft 110 at positions spaced apart in the shaft direction of the rotation shaft 110.

The angle sensor 130 is generally provided slightly further forward on the rotation shaft 110 than the front-side shaft vibration sensors 121.

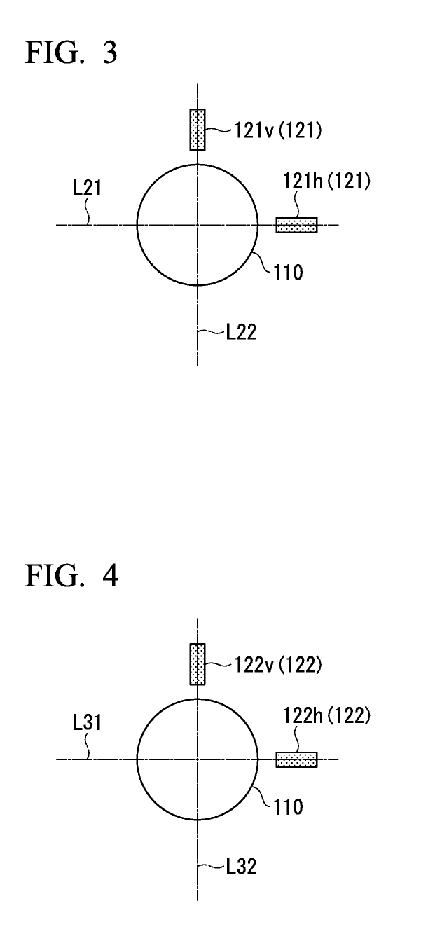

FIG. 3 is a diagram which shows an example of installation positions of the front-side shaft vibration sensors 121 in the circumferential direction of the rotation shaft 110. FIG. 3 shows an example of a case in which the rotation shaft 110 and the front-side shaft vibration sensors 121 are seen from the front side of the rotation shaft 110, and shows the two front-side shaft vibration sensors 121 and a cross-sectional view of the rotation shaft 110 at positions of the front-side shaft vibration sensors 121 in the shaft direction of the rotation shaft 110.

The two front-side shaft vibration sensors 121 are provided in a horizontal direction and a vertical direction with respect to the rotation shaft 110. The front-side shaft vibration sensor 121 in the horizontal direction with respect to the rotation shaft 110 is referred to as a horizontal front-side shaft vibration sensor 121h. The front-side shaft vibration sensor 121 in the vertical direction with respect to the rotation shaft 110 is referred to as a vertical front-side shaft vibration sensor 121v.

A line L21 is a line obtained by extending a horizontal diameter among the diameters of the rotation shaft 110. The horizontal front-side shaft vibration sensor 121h is provided on the extension of the horizontal diameter among the diameters of the rotation shaft 110. A line L22 is a line obtained by extending a vertical diameter among the diameters of the rotation shaft 110. The vertical front-side shaft vibration sensor 121v is provided on the extension of the vertical diameter among the diameters of the rotation shaft 110. The horizontal diameter and the vertical diameter of the rotation shaft 110 are orthogonal to each other. Accordingly, the shaft vibration sensors 120 are provided in respective diameter directions of the rotation shaft 110 orthogonal to each other in the arrangement of FIG. 3.

FIG. 4 is a diagram which shows an example of installation positions of the rear-side shaft vibration sensors 122 in the circumferential direction of the rotation shaft 110. FIG. 4 shows an example of a case in which the rotation shaft 110 and the rear-side shaft vibration sensors 122 are seen from the front side of the rotation shaft 110, and shows the two rear-side shaft vibration sensors 122 and a cross-sectional view of the rotation shaft 110 at positions of the rear-side shaft vibration sensors 122 in the shaft direction of the rotation shaft 110.

The two rear-side shaft vibration sensors 122 are provided in the horizontal direction and the vertical direction with respect to the rotation shaft 110. The rear-side shaft vibration sensor 122 in the horizontal direction with respect to the rotation shaft 110 is referred to as a horizontal rear-side shaft vibration sensor 122h. The rear-side shaft vibration sensor 122 in the vertical direction with respect to the rotation shaft 110 is referred to as a vertical rear-side shaft vibration sensor 122v.

A line L31 is a line obtained by extending the horizontal diameter among the diameters of the rotation shaft 110. The horizontal rear-side shaft vibration sensor 122his provided on the extension of the horizontal diameter among the diameters of the rotation shaft 110. A line L32 is a line obtained by extending the vertical diameter among the diameters of the rotation shaft 110. The vertical rear-side shaft vibration sensor 122v is provided on the extension of the vertical diameter among the diameters of the rotation shaft 110. The horizontal diameter and the vertical diameter of the rotation shaft 110 are orthogonal to each other. Accordingly, the shaft vibration sensors 120 are provided in respective diameter directions of the rotation shaft 110 orthogonal to each other in an arrangement of FIG. 4.

However, the number and arrangement of the shaft vibration sensors 120 and the angle sensor 130 are not limited to those shown in FIGS. 2 to 4. The shaft vibration sensors 120 may be provided at three or more places in the shaft direction of the rotation shaft 110. In addition, three or more of shaft vibration sensors 120 may also be provided in a circumferential direction of the rotation shaft 110. Moreover, the shaft vibration sensors 120 may also be provided in an arrangement other than diameter directions of the rotation shaft 110 that are orthogonal to each other, such as being provided on an upper side and an obliquely lower side of the rotation shaft 110.

A position of the angle sensor 130 is not limited to the position shown in FIG. 2, and may be any position as long as the rotation angle of the rotation shaft 110 can be measured. In addition, two or more angle sensors 130 may also be provided such as spare angle sensors 130 being provided.

The abnormality detection device 200 detects an abnormality in the vibration of the rotation shaft 110, and estimates an occurrence position of the abnormality which causes abnormality vibration.

The abnormality detection device 200 is configured, for example, using a computer such as an engineering workstation (EWS) or a computer (a personal computer; PC).

The communication unit 210 communicates with other devices. In particular, the communication unit 210 receives sensor measurement values from each shaft vibration sensor 120 and the angle sensor 130.

The operation input unit 220 includes, for example, an input device such as a keyboard or a mouse, and receives a user operation. For example, the operation input unit 220 receives a setting operation for determination conditions (for example, a determination threshold value) to determine the presence or absence of an abnormality in the vibration of the rotation shaft 110. A user can select a level of vibration which is determined as an abnormality by setting the determination conditions.

The display unit 230 includes, for example, a display screen such as a liquid crystal panel or a light emitting diode (LED), and displays various types of images. In particular, the display unit 230 displays an estimation result of an abnormality occurrence position of the rotation shaft 110.

The storage unit 280 stores various types of data. In particular, the storage unit 280 stores data in which a vibration situation and an abnormality occurrence position of the rotation shaft 110 are associated with each other for estimating the abnormality occurrence position of the rotation shaft 110. In the following description, the data in which the vibration situation and the abnormality occurrence position of the rotation shaft 110 are associated with each other is referred to as abnormality occurrence position data. As will be described below, the storage unit 280 stores abnormality occurrence position data in which a rotation speed of the rotation shaft 110, a difference vector of the rotation shaft 110 calculated by the difference vector calculation unit 293, an abnormality occurrence position in the shaft direction of the rotation shaft 110, and an abnormality occurrence position in the circumferential direction of the rotation shaft 110 are associated with each other. The storage unit 280 stores an abnormality occurrence position data group in which a plurality of pieces of abnormality occurrence position data are converted into a database.

The storage unit 280 is configured to use a storage device included in the abnormality detection device 200.

The control unit 290 performs various types of processing by controlling each unit of the abnormality detection device 200. The control unit 290 is configured by a central processing unit (CPU) included in the abnormality detection device 200 reading a program from the storage unit 280 and executing it.

The vibration measurement value acquisition unit 291 acquires a measurement value of the vibration of the rotation shaft 110 measured by the shaft vibration sensors 120 for each rotation angle of the rotation shaft 110. Specifically, the vibration measurement value acquisition unit 291 associates a measurement value of the vibration of the rotation shaft 110 measured by the shaft vibration sensors 120 with an angle on the rotation shaft with an inter-pulse of the rotation pulse sensor set as 360 degrees for each shaft vibration sensor 120, and acquires a measurement value of one round of vibration of the rotation shaft 110 (for example, measurement values of distances between the shaft vibration sensors 120 and the rotation shaft 110 or measurement values of displacement of the distances).

The vibration measurement value acquisition unit 291 may also extract data for one round of the rotation shaft 110 from the measurement value of the vibration of the rotation shaft 110 measured by the shaft vibration sensors 120. Alternatively, the vibration measurement value acquisition unit 291 may acquire the measurement value of the vibration of the rotation shaft 110 for a plurality of rounds of the rotation shaft 110 measured by the shaft vibration sensor 120, and may also calculate an average for each rotation angle.

The vibration vector calculation unit 292 calculates a vibration vector which indicates an angle on a rotor (the rotation shaft 110) at which the vibration of the rotation shaft 110 is a maximum and a magnitude of the vibration on the basis of the measurement value of the vibration acquired by the vibration measurement value acquisition unit 291.

The vibration vector calculation unit 292 calculates a vibration vector for each shaft vibration sensor 120. However, a unit in which the vibration vector calculation unit 292 calculates the vibration vector is not limited to each shaft vibration sensor 120. For example, the vibration vector calculation unit 292 may calculate a vibration vector associated with the plurality of shaft vibration sensors 120 on the basis of an average of the measurement value of the vibration measured by the plurality of shaft vibration sensors 120.

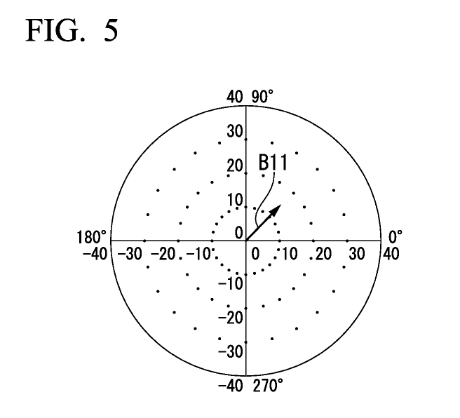

FIG. 5 is a diagram which shows an example of an initial value of a vibration vector calculated by the vibration vector calculation unit 292. A coordinate axis of the graph of FIG. 5 shows the magnitude of vibration and polar coordinates of a circumferential angle to a rotation pulse reference point on the rotation shaft 110. The rotation pulse reference point is indicated by, for example, a reflective tape or slit.

A vector B11 shows an example of a vibration vector. A vibration vector indicates an angle on the rotation shaft (an angle from the rotation pulse reference point) at which the shaft vibration of the rotation shaft 110 at the measured number of rotations measured by the vibration measurement value acquisition unit 291 is a maximum

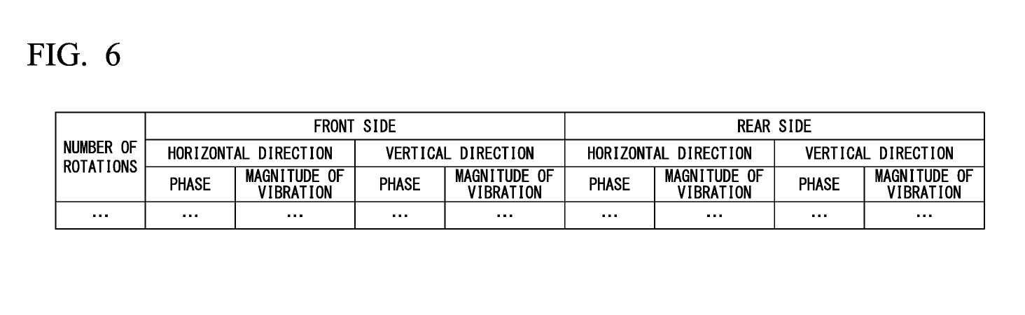

FIG. 6 is a diagram which shows an example of a data structure of vibration vector initial value data stored in the storage unit 280.

In the example of FIG. 6, the vibration vector initial value data stores magnitudes of a phase and vibration as vibration vector initial values of each of the horizontal front-side shaft vibration sensor 121h, the vertical front-side shaft vibration sensor 121v, the horizontal rear-side shaft vibration sensor 122h, and the vertical rear-side shaft vibration sensor 122v. In addition, the vibration vector initial value data stores the number of rotations of the rotation shaft 110. Since the vibration vector also changes if the number of rotations of the rotation shaft 110 changes, the storage unit 280 stores the vibration vector initial value data for each rotation speed of the rotation shaft 110.

Alternatively, in a case in which the abnormality detection device 200 operates only when the rotation shaft 110 rotates at a predetermined speed such as performing abnormality detection only when the rotation shaft 110 rotates at a rated speed, the “number of rotations” column in the vibration vector initial value data is unnecessary. The storage unit 280 may store a vibration vector initial value at a predetermined speed.

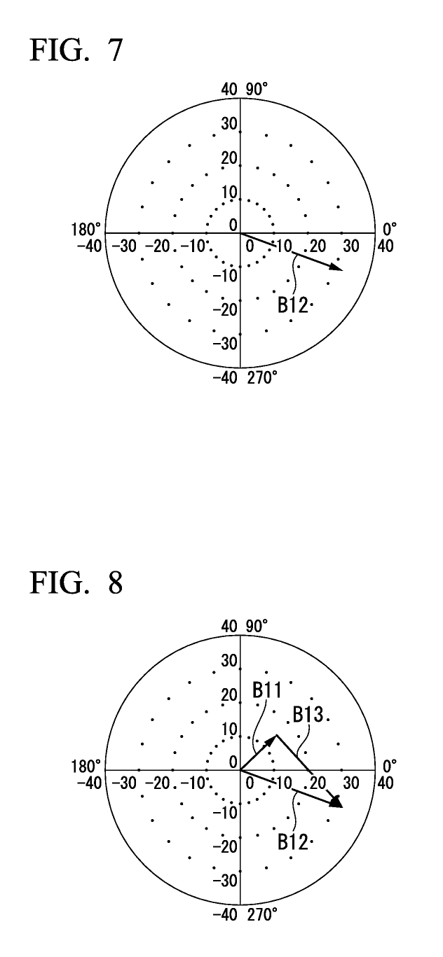

FIG. 7 is a diagram which shows an example of a vibration vector after the vibration of the rotation shaft 110 has changed. A coordinate axis of the graph of FIG. 7 shows the same polar coordinates as that of the graph of FIG. 5.

A vector B12, like the vector B11 in FIG. 5, shows an example of the vibration vector according to a vibration measurement value of the shaft vibration sensor 120. When the vibration changes due to, for example, an occurrence of an abnormality such as a crack in the rotation shaft 110, the vibration vector also changes from the vector B11 to the vector B12.

In the following description, a vibration vector obtained based on a vibration measurement value measured by the shaft vibration sensor 120 is referred to as a vibration vector of the shaft vibration sensor 120.

The difference vector calculation unit 293 calculates a difference vector. A difference vector herein is a vector indicating a time change in the vibration vector. Specifically, the difference vector is a vector obtained by subtracting the vibration vector initial value of a corresponding shaft vibration sensor 120 from a vibration vector of the vibration measurement value of the shaft vibration sensor 120.

FIG. 8 is a diagram which shows a calculation example of the difference vector. A coordinate axis of the graph of FIG. 8 shows the same polar coordinates as that of the graph of FIG. 5.

In FIG. 8, the vector B11 which is a vibration vector initial value described with reference to FIG. 5, and a vector B12 which is a vibration vector described with reference to FIG. 7 are shown. The vector B13 is a vector obtained by subtracting the vector B11 from the vector B12, and corresponds to an example of the difference vector.

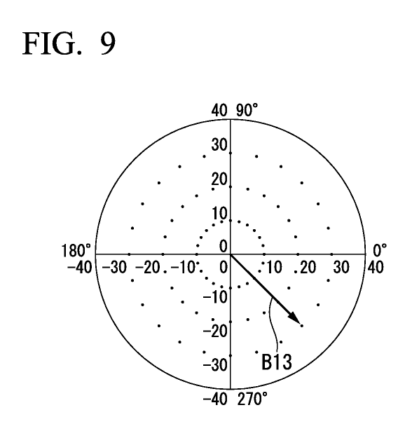

FIG. 9 is a diagram which shows a display example of the difference vector. A coordinate axis of the graph of FIG. 9 shows the same polar coordinates as that of the graph of FIG. 5.

In FIG. 9, the vector B13 which is a difference vector described with reference to FIG. 8 is shown to start from the origin of a coordinate axis.

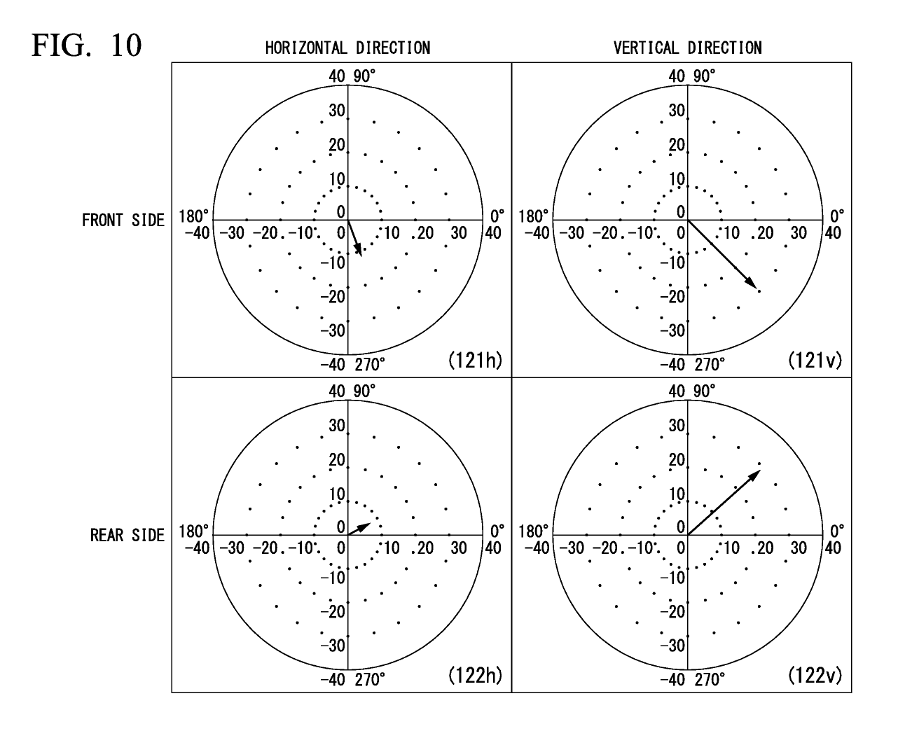

FIG. 10 is a diagram which shows examples of difference graphs calculated by the difference vector calculation unit 293 for each shaft vibration sensor 120. A coordinate axis of each graph of FIG. 10 shows polar coordinates in the same manner as the graph of FIG. 5. In FIG. 10, difference vectors of each of the horizontal front-side shaft vibration sensor 121h, the vertical front-side shaft vibration sensor 121v, the horizontal front-side shaft vibration sensor 121h, and the vertical front-side shaft vibration sensor 121v are shown.

In this manner, the difference vector calculation unit 293 calculates a difference vector for each shaft vibration sensor 120 (for each unit in which the vibration vector calculation unit 292 calculates a vibration vector).

The estimation unit 294 estimates an abnormality occurrence position in the shaft direction of the rotation shaft 110 on the basis of a time change in the vibration vector. Specifically, apart from the actual measurement values described above, a shaft vibration analysis is performed on the rotary machine 100 to be evaluated. In the shaft vibration analysis, a calculated value of a change in the vibration vector (an effect vector) of each of the horizontal direction and the vertical direction of each bearing position when unit imbalance is installed at each position in the shaft direction of the rotor is converted into a database. Then, a unit imbalance position of a calculated value with which these vectors are closest is selected by comparing a difference vector of the vibration vector between before the occurrence of an abnormality and after the occurrence of an abnormality with an effect vector of the calculated database.

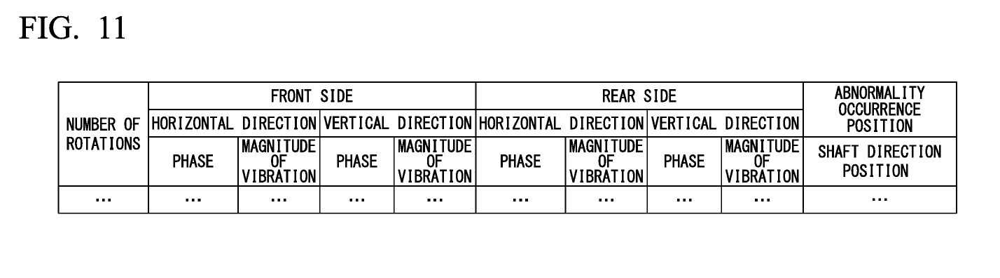

FIG. 11 is a diagram which shows an example of a data structure of abnormality occurrence position data stored in the storage unit 280.

In the example of FIG. 11, the abnormality occurrence position data includes the “number of rotations” column, a “phase” column and a “magnitude of vibration” column for each shaft vibration sensor 120, and a “shaft direction position” of an abnormality occurrence position column.

The “rotation speed” column stores the rotation speed of the rotation shaft 110. As the rotation speed of the rotation shaft 110, for example, the control unit 290 calculates the number of rotations according to the rotation pulse sensor (the angle sensor 130).

Alternatively, in a case in which the abnormality detection device 200 operates only when the rotation shaft 110 rotates at a predetermined speed such as performing abnormality detection only when the rotation shaft 110 rotates at a rated speed, the “rotation speed” column in the abnormality occurrence position data is unnecessary.

The “rotation angle” column and the “magnitude of vibration” for each shaft vibration sensor 120 store a rotation angle and the magnitude of vibration in the vibration vector of a corresponding shaft vibration sensor 120.

A “front and rear position” column and a “circumferential position” column of an abnormality occurrence position store an abnormality occurrence position in the rotation shaft 110 at a position in the shaft direction of the rotation shaft 110 and a position in the circumferential direction thereof. The shaft direction of the rotation shaft 110 (a longitudinal direction of the rotation shaft 110) is also referred to as a front and rear direction of the rotation shaft 110.

A method of acquiring abnormality occurrence position data stored in the storage unit 280 is not limited to a specific method.

For example, the storage unit 280 may also store abnormality occurrence position data obtained at the time of maintenance and inspection of the rotary machine 100. When a maintenance worker detects an abnormality of the rotation shaft 110 at the time of maintenance and inspection of the rotary machine 100, the worker records a position in the front and rear direction of the rotation shaft 110 and a position in the circumferential direction of the rotation shaft 110 as a position of the detected abnormality. In addition, the maintenance worker reads a history of the rotation speed and vibration vector of the rotation shaft 110 in the past within a predetermined period from the maintenance and inspection from history data of the abnormality detection device 200. Then, the maintenance worker generates the history of the rotation speed and the vibration vector of the rotation shaft 110 and abnormality occurrence position data in the front and rear direction of the rotation shaft 110, and causes the storage unit 280 to store them. The abnormality occurrence position data obtained at the time of maintenance and inspection of the rotary machine 100 is not limited to data at the time of maintenance and inspection of the rotary machine 100 which is a target for abnormality detection, and it is also possible to use data at the time of maintenance and inspection of another rotary machine 100 of the same type.

Alternatively, the storage unit 280 may also store abnormality occurrence position data obtained by a real machine test of the same type of rotary machine 100. An examination conductor causes, for example, an abnormality such as a crack or deposit to occur in the rotation shaft 110 of the rotary machine 100 to be tested, and inputs an abnormality occurrence position from the operation input unit 220. Then, the examination conductor operates the rotary machine 100 to cause the rotation shaft 110 to rotate in a state in which an abnormality occurs in the rotation shaft 110. In the abnormality detection device 200, the control unit 290 calculates the rotation speed of the rotation shaft 110 and the difference vector calculation unit 293 calculates a difference vector. Then, the control unit 290 generates abnormality occurrence position data by combining the rotation speed and difference vector of the rotation shaft 110 and the abnormality occurrence position, and causes the storage unit 280 to store it.

Alternatively, the storage unit 280 may also store an abnormality occurrence data group in which abnormality occurrence position data obtained in each of a plurality of methods is combined.

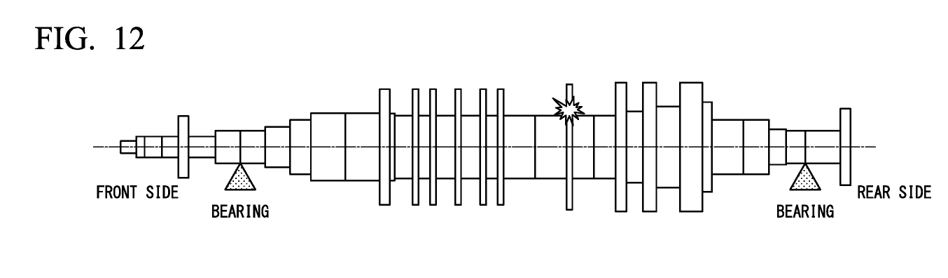

FIG. 12 is a diagram which shows a display example of an abnormality occurrence position in the rotation shaft 110. In the example of FIG. 12, the display unit 230 displays an abnormality occurrence position estimated by the estimation unit 294 under control of the control unit 290.

The display unit 230 displays a failure occurrence position in the front and rear direction of the rotation shaft 110 in a side view in which the rotation shaft 110 is seen in the horizontal direction, and the diameter direction of the rotation shaft 110 (a direction orthogonal to the shaft direction).

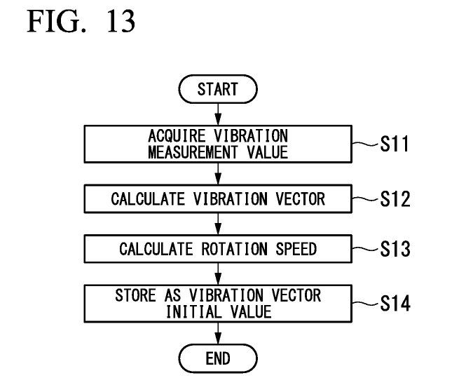

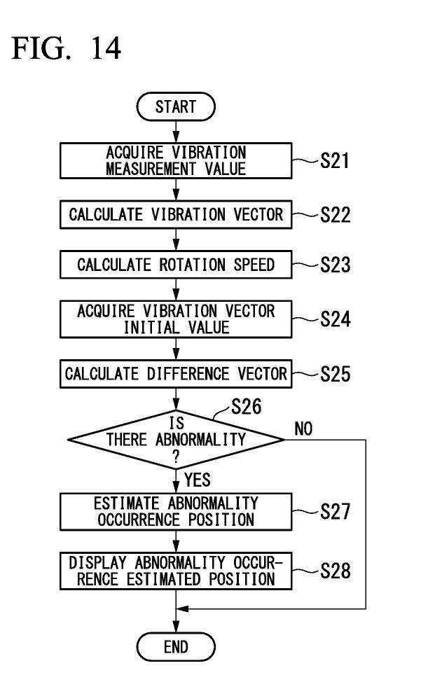

Next, an operation of the abnormality detection device 200 will be described with reference to FIGS. 13 and 14. FIG. 13 is a flowchart which shows an example of a processing procedure in which the abnormality detection device 200 generates and stores a vibration vector initial value. The abnormality detection device 200 performs processing of FIG. 13 if a user operation instructing, for example, the generation of a vibration vector initial value is received in a state in which the rotary machine 100 is normal (in particular, in a state in which an abnormality does not occur in the rotation shaft 110).

In the processing of FIG. 13, the vibration measurement value acquisition unit 291 acquires a vibration measurement value for each rotation of the rotation shaft 110 (step S11). The vibration measurement value acquisition unit 291 associates a measurement value of the vibration of the rotation shaft 110 measured by the shaft vibration sensor 120 with a rotation angle measurement value of the rotation shaft 110 measured by the angle sensor 130, and acquires a vibration measurement value for each rotation angle of the rotation shaft 110. The vibration measurement value acquisition unit 291 acquires a vibration measurement value for each rotation angle of the rotation shaft 110 for each shaft vibration sensor 120.

Next, the vibration vector calculation unit 292 calculates a vibration vector based on a vibration measurement value for each rotation angle of the rotation shaft 110 acquired by the vibration measurement value acquisition unit 291 (step S12). Specifically, the vibration vector calculation unit 292 detects a maximum value of the vibration and a rotation angle of the rotation shaft 110 at which the vibration has a maximum value based on a vibration measurement value for each rotation angle of the rotation shaft 110, thereby calculating a vibration vector.

In addition, the control unit 290 calculates the rotation speed of the rotation shaft 110 (step S13). Specifically, the control unit 290 calculates the number of rotations of the rotation shaft 110 per unit time on the basis of the rotation angle measurement value of the rotation shaft 110 measured by the angle sensor 130.

Then, the vibration vector calculation unit 292 causes the vibration vector calculated in step S12 to be stored in the storage unit 280 as a vibration vector initial value (step S14).

As described with reference to FIG. 6, the vibration vector calculation unit 292 causes vibration vector initial value data including the rotation speed of the rotation shaft 110 and the vibration vector for each shaft vibration sensor 120 to be stored in the storage unit 280.

After step S14, the processing of FIG. 13 ends.

The abnormality detection device 200 may calculate and store a vibration vector initial value for each rotation speed of the rotation shaft 110, for example, during a speed-up operation of the rotary machine 100.

Alternatively, in a case in which the abnormality detection device 200 operates only when the rotation shaft 110 rotates at a predetermined speed such as performing abnormality detection only when the rotation shaft 110 rotates at a rated speed, the “rotation speed” column in the vibration vector initial value data is unnecessary. In this case, the storage unit 280 may store the vibration vector initial value data at the predetermined speed.

In addition, when the vibration vector in the state in which the rotary machine 100 is normal is changed due to aging and the like, the abnormality detection device 200 may update the vibration vector initial value data. For example, the abnormality detection device 200 may receive a user operation instructing the generation of a vibration vector initial value, perform the processing of FIG. 13, and update the vibration vector initial value data at a timing at which it is confirmed that the rotary machine 100 is normal at a periodic inspection.

FIG. 14 is a flowchart which shows an example of a processing procedure in which the abnormality detection device 200 estimates an abnormality occurrence position in the rotation shaft 110.

For example, the abnormality detection device 200 performs the processing of FIG. 14 if a user operation instructing abnormality detection is received. Alternatively, the processing of FIG. 14 may be made to be automatically performed such as the abnormality detection device 200 periodically performing the processing of FIG. 14.

Steps S21 to S23 of FIG. 14 are the same as steps S11 to S13 of FIG. 13. After step S23, the difference vector calculation unit 293 acquires a vibration vector initial value (step S24). Specifically, the difference vector calculation unit 293 reads vibration vector initial value data in accordance with the number of rotations of the rotation shaft 110 obtained in step S23 from the storage unit 280.

Next, the difference vector calculation unit 293 calculates a difference vector for each shaft vibration sensor 120 (step S25). Specifically, the difference vector calculation unit 293 subtracts the vibration vector initial value from the vibration vector obtained in step S22 for each shaft vibration sensor 120.

Next, the estimation unit 294 determines the presence or absence of an abnormality in the rotation shaft 110 (step S26). For example, the estimation unit 294 compares a maximum value in the magnitude of vibration indicated by the vibration vector of each shaft vibration sensor 120 with a threshold value stored in advance by the storage unit 280. When the magnitude of vibration is larger than the threshold value, the estimation unit 294 determines that there is an abnormality in the rotation shaft 110. On the other hand, when the magnitude of vibration is equal to or less than the threshold value, the estimation unit 294 determines that there is no abnormality in the rotation shaft 110.

Alternatively, the estimation unit 294 may also determine the presence or absence of an abnormality in the rotation shaft 110 on the basis of a change amount in the magnitude of vibration in addition to or instead of the magnitude of vibration indicated by a difference vector.

For example, the storage unit 280 stores a history of a difference vector. The estimation unit 294 calculates a magnitude of a vector obtained by subtracting a previous value from a present value of a difference vector for each shaft vibration sensor 120 as the change amount in the magnitude of vibration. The estimation unit 294 compares a maximum value of the change amount in the magnitude of vibration calculated for each shaft vibration sensor 120 with a threshold value stored in advance in the storage unit 280. When the change amount is larger than the threshold value, the estimation unit 294 determines that there is an abnormality in the rotation shaft 110. On the other hand, when the change amount is equal to or less than the threshold value, the estimation unit 294 determines the presence or absence of an abnormality in the rotation shaft 110 on the basis of the magnitude of vibration indicated by a difference vector.

When it is determined that there is no abnormality in step S26 (NO in step S26), the processing of FIG. 14 ends.

On the other hand, when it is determined that there is an abnormality in step S26 (YES in step S26), the estimation unit 294 estimates an abnormality occurrence position in the rotation shaft 110 (step S27). The estimation unit 294 selects (searches for) abnormality occurrence position data closest to a rotation speed obtained in step S23 and a difference vector for each shaft vibration sensor 120 obtained in step S25 among the abnormality occurrence position data stored in the storage unit 280. Then, the estimation unit 294 estimates an abnormality occurrence position by reading an abnormality occurrence position from obtained abnormality occurrence position data.

Next, the display unit 230 displays the abnormality occurrence position estimated by the estimation unit 294 under the control of the control unit 290 (step S28). For example, the display unit 230 displays an abnormality occurrence position in the shaft direction of the rotation shaft 110 and an abnormality occurrence position in the circumferential direction of the rotation shaft 110 as shown in the example of FIG. 12.

After step S28, the processing of FIG. 14 ends.

As described above, the plurality of shaft vibration sensors 120 are provided to be spaced apart in the diameter direction of the rotation shaft 110 with respect to the outer circumferential surface of the rotation shaft 110 at positions spaced apart in the shaft direction of the rotation shaft 110. The vibration measurement value acquisition unit 291 acquires a measurement value of the vibration of the rotation shaft 110 measured by the shaft vibration sensor 120 for each rotation angle of the rotation shaft 110. The vibration vector calculation unit 292 calculates a vibration vector indicating a rotation angle at which the vibration of the rotation shaft 110 is a maximum and the magnitude of the vibration on the basis of the measurement value of the vibration acquired by the vibration measurement value acquisition unit 291. The estimation unit 294 estimates an abnormality occurrence position in the shaft direction of the rotation shaft 110 on the basis of a time change in the vibration vector.

According to the abnormality detection device 200, it is possible to obtain information for the maintenance work of the rotary machine 100 in that an estimation value of an abnormality occurrence position in the shaft direction of the rotation shaft 110 is obtained.

For example, in a previous step in which the rotary machine 100 is stopped by detecting an abnormality vibration, if an abnormality occurrence position in the shaft direction of the rotation shaft 110 can be estimated, there is a possibility that a required replacement part can be specified and prepared. When the rotary machine 100 is a steam turbine, it is possible to specify at which blade an abnormality has occurred by specifying an abnormality occurrence position in the shaft direction of the rotation shaft 110, and a blade for replacement can be prepared in advance.

In addition, a maintenance worker ascertains a position estimated as a position at which an abnormality has occurred at the time of the maintenance work of the rotary machine 100, and thereby it is expected that an abnormality can be found earlier and a possibility of overlooking an abnormality can be reduced.

In addition, the shaft vibration sensor 120 measures the vibration of the rotation shaft 110 in a plurality of directions among the circumferential directions of the rotation shaft 110, thereby avoiding overlooking the vibration.

If the shaft vibration sensor 120 is installed only in the horizontal direction with respect to the rotation shaft 110, if the rotation shaft 110 vibrates only in the vertical direction, a vibration measurement value measured by the shaft vibration sensor 120 is not large, and the abnormality detection device 200 may underestimate the magnitude of the vibration. On the other hand, the shaft vibration sensor 120 measures the vibration of the rotation shaft 110 in a plurality of directions among the circumferential directions of the rotation shaft 110, and thereby, even if the rotation shaft 110 vibrates in any one direction, at least one of the vibration measurement values of the shaft vibration sensor 120 is large, and a possibility that the abnormality detection device 200 can detect a vibration is increased.

Moreover, the estimation unit 294 estimates an abnormality occurrence position on the basis of a time change in the vibration vector, thereby estimating an abnormality occurrence position by removing the influence of vibration at the time of the rotary machine 100 being normal, and estimating an abnormality occurrence position with high accuracy in this regard.

Here, the rotation shaft 110 also vibrates even when the rotary machine 100 is normal. If this vibration serves as an offset for a vibration measurement value at the time of estimating an abnormality occurrence position, it is considered that estimation accuracy of an abnormality occurrence position can be lowered. On the other hand, a vibration component at the time of the rotary machine 100 being normal is removed in a time change in the vibration vector (for example, a difference vector). The estimation unit 294 estimates an abnormality occurrence position on the basis of a time change in the vibration vector, thereby estimating an abnormality occurrence position by removing the influence of vibration at the time of the rotary machine 100 being normal, and estimating an abnormality occurrence position with high accuracy in this regard.

In addition, it is considered that the vibration at the time of the rotary machine 100 being normal is different for each rotary machine 100. When the storage unit 280 stores abnormality occurrence position data obtained from another rotary machine 100 of the same type, the estimation unit 294 searches for the abnormality occurrence position data with a time change in the vibration vector set as an index, thereby performing a search by influence of individual differences for each rotary machine 100. In this regard, the estimation unit 294 can estimate an abnormality occurrence position with high accuracy.

In addition, the shaft vibration sensor 120 is provided in each of the diameter directions of the rotation shaft 110 orthogonal to each other.

As a result, even if the rotation shaft 110 vibrates in any direction, at least one of the vibration measurement values of the shaft vibration sensor 120 is large, and a possibility that the abnormality detection device 200 can detect a vibration is increased.

Moreover, phase matching of the vibration vectors of two shaft vibration sensors 120 can be performed in a relatively easy manner. Phase matching of the vibration vectors herein means to align coordinates of the rotation angles of the rotation shaft 110 as shown in FIG. 10.

In addition, the estimation unit 294 estimates an abnormality occurrence position in the shaft direction of the rotation shaft 110 on the basis of the rotation speed of the rotation shaft 110 in addition to the time change in the vibration vector. If the rotation speed of the rotation shaft 110 changes, the vibration vector may also change. The estimation unit 294 estimates an abnormality occurrence position in the shaft direction of the rotation shaft 110 on the basis of the rotation speed of the rotation shaft 110 in addition to the time change in the vibration vector, thereby estimating an abnormality occurrence position with higher accuracy.

### Second Embodiment

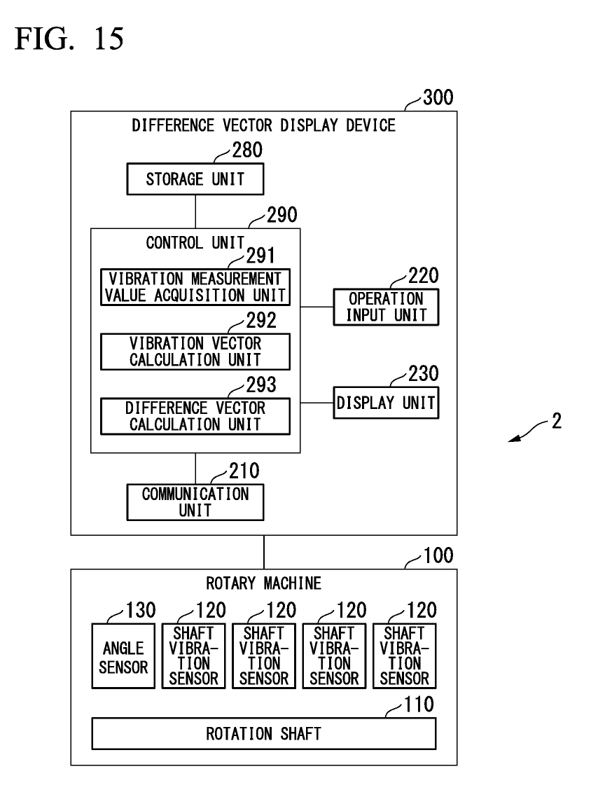

FIG. 15 is a schematic block diagram which shows a functional configuration of a rotary machine system according to a second embodiment of the present invention. As shown in FIG. 15, a rotary machine system 2 includes the rotary machine 100 and a difference vector display device 300.

The rotary machine 100 includes the rotation shaft 110, the shaft vibration sensor 120, and the angle sensor 130. The difference vector display device 300 includes the communication unit 210, the operation input unit 220, the display unit 230, the storage unit 280, and the control unit 290. The control unit 290 includes the vibration measurement value acquisition unit 291, the vibration vector calculation unit 292, and the difference vector calculation unit 293.

The same reference numerals (100, 110, 120, 130, 210, 220, 230, 280, 290, 291, 292, and 293) are assigned to parts of FIG. 15 having the same functions corresponding to respective parts of FIG. 1, and descriptions thereof will be omitted.

The rotary machine system 2 shown in FIG. 15 is different from the rotary machine system 1 shown in FIG. 1 in that it includes a difference vector display device 300 instead of the abnormality detection device 200. The difference vector display device 300 is different from the abnormality detection device 200 in that it includes the estimation unit 294. In other respects, the rotary machine system 2 is the same as the rotary machine system 1.

The abnormality detection device 200 displays a result of the estimation of an abnormality occurrence position, whereas the difference vector display device 300 displays a difference vector. The display unit 230 of the difference vector display device 300, for example, displays a difference vector of each shaft vibration sensor 120 as shown in the example of FIG. 10 under control of the control unit 290.

The display unit 230 displays a difference vector, and thereby a user of the difference vector display device 300 (an administrator of the rotary machine 100) can ascertain the phase and magnitude of vibration in the rotation shaft 110, and use them as a reference for estimating an abnormality occurrence position in the rotation shaft 110.

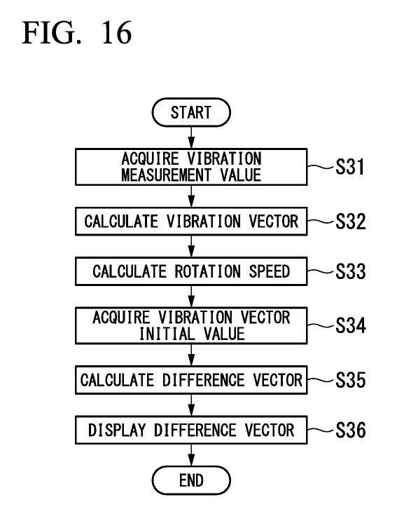

Next, an operation of the difference vector display device 300 will be described with reference to FIG. 16.

FIG. 16 is a flowchart which shows an example of a processing procedure in which the difference vector display device 300 calculates and displays a difference vector.

Steps S31 to S35 of FIG. 16 are the same as steps S21 to S25 of FIG. 14. After step S35, the display unit 230 displays a difference vector obtained for each shaft vibration sensor 120 in step S35 under the control of the control unit 290 (step S36).

After step S36, the processing of FIG. 16 ends.

As described above, the plurality of shaft vibration sensors 120 are provided to be spaced apart in the diameter direction of the rotation shaft 110 with respect to the outer circumferential surface of the rotation shaft 110 and provided to be spaced apart in the shaft direction of the rotation shaft 110. The vibration measurement value acquisition unit 291 acquires a measurement value of the vibration of the rotation shaft 110 measured by the shaft vibration sensor 120 for each rotation angle of the rotation shaft 110. The vibration vector calculation unit 292 calculates a vibration vector indicating a rotation angle at which the vibration of the rotation shaft 110 is a maximum and the magnitude of the vibration on the basis of the measurement value of the vibration acquired by the vibration measurement value acquisition unit 291. The difference vector calculation unit 293 calculates a difference vector indicating a time change in the vibration vector. The display unit 230 displays a difference vector. The display unit 230 displays a difference vector, and thereby a user of the difference vector display device 300 (for example, an administrator of the rotary machine 100) can ascertain the phase and magnitude of vibration in the rotation shaft 110, and use them as a reference for estimating an abnormality occurrence position in the rotation shaft 110.

The processing of each unit may be performed by recording a program for realizing all or a part of functions of the control unit 290 in a computer-readable recording medium, and causing a computer system to read and execute the program recorded in this recording medium. “Computer system” herein includes hardware such as an OS and peripheral devices. In addition, “computer system” also includes a homepage-providing environment (or a display environment) if it uses a WWW system.

In addition, “computer-readable recording medium” refers to a storage device such as a portable medium such as a flexible disk, a magneto-optical disc, a ROM, a CD-ROM, and a hard disk embedded in a computer system. Moreover, the program may be one for realizing a part of the functions described above, or may be a program for realizing the functions described above in combination with a program already recorded in the computer system.

As described above, the embodiments of the present invention have been described in detail with reference to drawings, but a specific configuration is not limited to the embodiments, and design changes and the like within a scope not departing from the gist of this invention are also included.

What is claimed is:

1. An abnormality detection device comprising:
a vibration measurement value acquisition unit configured to acquire a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft;
a vibration vector calculation unit configured to calculate a vibration vector, the vibration vector indicating a rotation angle at which vibration of the rotation shaft is a maximum and a magnitude of the vibration on the basis of the measurement value of the vibration; and
an estimation unit configured to estimate an abnormality occurrence position in the shaft direction of the rotation shaft on the basis of a time change in the vibration vector.

2. The abnormality detection device according to claim 1, wherein the shaft vibration sensors are provided in respective diameter directions of the rotation shaft orthogonal to each other.

3. The abnormality detection device according to claim 1,
wherein the estimation unit estimates an abnormality occurrence position in the shaft direction of the rotation shaft on the basis of a rotation speed of the rotation shaft in addition to a time change in the vibration vector.

4. A difference vector display device comprising:
a vibration measurement value acquisition unit configured to acquire a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft;
a vibration vector calculation unit configured to calculate a vibration vector, the vibration vector indicating a rotation angle at which vibration of the rotation shaft is a maximum and a magnitude of the vibration on the basis of the measurement value of the vibration;
a difference vector calculation unit configured to calculate a difference vector indicating a time change in the vibration vector; and
a display unit configured to display the difference vector.

5. A rotary machine system comprising:
a rotary machine; and
an abnormality detection device,
wherein the rotary machine includes:
a rotation shaft; and
a plurality of shaft vibration sensors provided to be spaced apart in a diameter direction of the rotation shaft with respect to an outer circumferential surface of the rotation shaft and provided to be spaced apart in a shaft direction of the rotation shaft, and
the abnormality detection device includes:
a vibration measurement value acquisition unit configured to acquire a measurement value of vibration of the rotation shaft measured by the shaft vibration sensor for each rotation angle of the rotation shaft;
a vibration vector calculation unit configured to calculate a vibration vector, the vibration vector indicating a rotation angle at which the vibration of the rotation shaft is a maximum and a magnitude of the vibration on the basis of the measurement value of the vibration; and
an estimation unit configured to estimate an abnormality occurrence position in the shaft direction of the rotation shaft on the basis of a time change in the vibration vector.

6. An abnormality detection method comprising:
acquiring a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft,
calculating a vibration vector, the vibration vector indicating a rotation angle at which vibration of the rotation shaft is a maximum and a magnitude of the vibration on the basis of the measurement value of the vibration; and
estimating an abnormality occurrence position in the shaft direction of the rotation shaft on the basis of a time change in the vibration vector.

7. A non-transitory computer-readable recording medium storing a program which causes a computer to execute:
acquiring a measurement value of vibration of a rotation shaft for each rotation angle of the rotation shaft, the measurement value being measured by each of a plurality of shaft vibration sensors, the plurality of shaft vibration sensors being provided to be spaced apart in a diameter direction of the rotation shaft with respect to an outer circumferential surface of the rotation shaft and being provided to be spaced apart in a shaft direction of the rotation shaft, for each rotation angle of the rotation shaft;
calculating a vibration vector, the vibration vector indicating a rotation angle at which vibration of the rotation shaft is a maximum and a magnitude of the vibration on the basis of the measurement value of the vibration; and
estimating an abnormality occurrence position in the shaft direction of the rotation shaft on the basis of a time change in the vibration vector.
